(19) United States
(12) Patent Application Publication
(10) Pub. No.: US 2026/0170667 A1
(43) Pub. Date: Jun. 18, 2026

(54) CROSS-DEVICE OBJECT TRACKING METHOD AND SYSTEM

(71) Applicants: INVENTEC APPLIANCES CORPORATION, New Taipei City (TW); INVENTEC APPLIANCES (PUDONG) CORPORATION, SHANGHAI (CN)

(72) Inventors: CHE-HUNG YEH, New Taipei City (TW); SHENG-HSIUNG HU, New Taipei City (TW)

(21) Appl. No.: 19/227,507

(22) Filed: Jun. 4, 2025

(30) Foreign Application Priority Data
Dec. 16, 2024 (TW) 113148890

(51) Int. Cl. G06T 7/292; G06T 7/246; G06V 10/74

(52) U.S. Cl. CPC G06T 7/292; G06T 7/248; G06V 10/761; G06T 2207/10016; G06T 2207/20084

(57) ABSTRACT

A cross-device object tracking method and a system are provided. The method is operated in the system including a device and at least one peripheral device. The device captures continuous frames and performs a multi-object tracking algorithm for detecting objects in a current frame and extracting object features of the objects. The current frame's object features are compared with those buffered from a previous frame in the device's original object pool to identify a new object. The object features of the new object are compared with the object features of a target object buffered in a target object pool for ensuring that the target object is captured. A control center designates the target object and multicasts the object features thereof to the devices. The devices collaboratively track the target object based on its features.

### CROSS-REFERENCE TO RELATED PATENT APPLICATION

This application claims the benefit of priority to Taiwan Patent Application No. 113148890, filed on Dec. 16, 2024. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to an object-tracking method, and more particularly to cross-device object tracking method collaboratively performed between multiple devices by sharing object features, and a system thereof.

### BACKGROUND OF THE DISCLOSURE

A conventional object-tracking method can be applied within a portable camera such as a body-worn camera (BWC). When chasing a suspect, for example, police officers or security personnel wearing the portable cameras collaboratively track or round up the suspect, and the suspect can only be positioned by continuously communicating with a control center according to the conventional technology. The conventional technology neither provides an effective technical solution to integrate multiple devices for tracking the suspect, nor effectively chases the suspect through the conventional control center by instantly communicating with the officers or personnel individually.

### SUMMARY OF THE DISCLOSURE

In certain embodiments of a cross-device object tracking method of the present disclosure, the method is collaboratively performed between a device and at least one peripheral device. Continuous frames are captured by a photographing module of the device, and a multi-object tracking algorithm detects at least one object in a current frame to obtain object features thereof. In the method, a new object can be obtained by comparing the object features of a previous frame buffered in an original object pool of the device. When the new object is identified, its object features are compared with a target object stored in a target object pool of the device. After confirming that the target object is captured, the at least one peripheral device can rely on the object features thereof stored in its own target object pool to collaboratively track the target object.

### BRIEF DESCRIPTION OF THE DRAWINGS

The described embodiments may be better understood by reference to the following description and the accompanying drawings, in which:

FIG. 1 is a schematic diagram depicting circuit elements of a device that operates a cross-device object tracking method according to one embodiment of the present disclosure;

FIG. 2 is a schematic diagram depicting a framework of a cross-device object tracking system according to one embodiment of the present disclosure;

FIG. 3 is a flowchart illustrating the cross-device object tracking method in one embodiment of the present disclosure;

FIG. 4 is another flowchart illustrating the cross-device object tracking method in another embodiment of the present disclosure;

FIG. 5 is a schematic diagram depicting an image frame being processed by rim-area computation according one embodiment of the present disclosure;

FIG. 6 is a schematic diagram depicting a framework that applies an embedding vector to track objects according to one embodiment of the present disclosure; and

FIG. 7 is a schematic diagram depicting a framework that implements a neural network of the cross-device object tracking method according to one embodiment of the present disclosure.

### DETAILED DESCRIPTION OF THE EXEMPLARY EMBODIMENTS

The present disclosure relates to a cross-device object tracking method and a system. The cross-device object tracking method is operated in a system including multiple devices. The device can be a fixed or a mobile electronic device with a photographic function. In an aspect of the present disclosure, multiple fixed or mobile cameras can be collaboratively operated for implementing the cross-device object tracking system. In one of the embodiments of the present disclosure, the device and the at least one peripheral device implementing the cross-device object tracking method communicate via a communication channel and can be individually implemented by an edge-computing device for operating a convolutional neural network (CNN) and a transformer model.

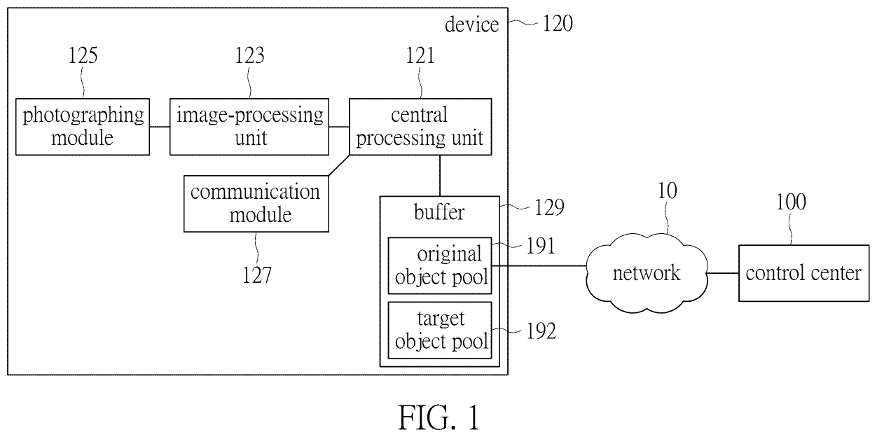

Reference is made to FIG. 1, which is a schematic diagram depicting multiple circuit elements of the device that operates the cross-device object tracking method according to one embodiment of the present disclosure. A device 120 shown in the diagram is a fixed device or a mobile device that is with a photographic function and can be communicated with a control center 100 via a network 10. The image data or related information generated by the device 120 can be transmitted to the control center 100 in real time, and the image data or the information can be processed in the control center 100 for determining an object to be tracked therefrom. After that, the control center 100 can notify the device 120 or the at least one peripheral device for achieving the purpose of cross-device object tracking.

One of main circuit elements of the device 120 is such as a central processing unit 121 that processes the image data and is electrically connected with an image-processing unit 123 that processes the motion images captured by a photographing module 125 to generate image signals. The central processing unit 121 performs a multi-object tracking (MOT) technology for frame-by-frame detecting objects in the image data according to image features and obtaining object features of the objects. In one aspect of the present disclosure, the device 120 can be operated as an edge-computing device. The central processing unit 121 can operate the convolutional neural network (CNN) for extracting the object features of one or more objects in each frame of the image data. After that, the transformer model is performed for transforming the object features of each of the objects into an embedding vector by an encoder of the transformer model, so that a decoder of the transformer model can identify the one or more objects by comparing the embedding vector of the object features of each of the objects in preceding and following frames.

The device 120 has a memory element that implements a buffer 129. The buffer 129 can be configured to embody an original object pool 191 and a target object pool 192. The original object pool 191 is used to buffer the object features of any object detected from a previous frame in the continuous frames, and the target object pool 192 stores object features of a target object. The object features thereof can be acquired from the control center 100.

The control center 100 can acquire images of the at least one object or the object features extracted from the object in each frame from the device 120. Alternatively, the control center 100 can also obtain the embedding vector transformed by the encoder of the transformer model from each of the objects. The above-mentioned images, object features, or the embedding vector can be transmitted by the communication module 127 to the control center 100 via the network 10. Afterwards, in an aspect of the present disclosure, the control center 100 determines the target object to be tracked and transmits the embedding vector of the target object to other peripheral devices via multicasting transmission.

According to one embodiment of the present disclosure, in the cross-device object tracking method, the central processing unit 121 of the device 120 extracts the object features of the at least one object in a current frame, and the object features of the at least one object are compared with the object features of a previous frame in the original object pool 191 to identify the object and determine if any new object enters the frame. If any new object is confirmed, the new object is assigned with an identifier. The object features thereof are stored in the target object pool 192 in advance and provided for the one or more peripheral devices to collaboratively track the target object.

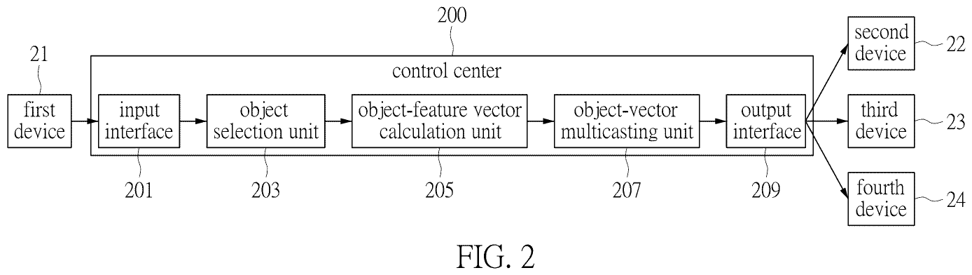

FIG. 2 schematically illustrates a control center 200 that is connected with multiple devices such as a first device 21, a second device 22, a third device 23 and a fourth device 24. The first device 21 captures continuous frames and detects at least one object from the continuous frames. The object features of the at least one object can then be extracted and transmitted to the control center 200 by a communication module of the first device 21 via an input interface 201.

According to one embodiment of the present disclosure, the object-tracking method operated in the control center 200 can be implemented by a trackformer that essentially includes a convolutional neural network and a transformer model. In one further embodiment of the present disclosure, the object-tracking method can be implemented by an object-tracking model such as Yolo (You Only Look Once) that is established through a deep-learning method. The trackformer includes multiple functional elements such as an object selection unit 203, an object-feature vector calculation unit 205 and an object-vector multicasting unit 207. The object selection unit 203 confirms the target object to be tracked from the objects in each frame. The object-feature vector calculation unit 205 transforms the object features to an embedding vector of the target object through calculation. Then, the object-vector multicasting unit 207 outputs the embedding vector of the target object to the peripheral devices in the same group via an output interface 209 according to the communication modes of these peripheral devices such as the second device 22, the third device 23 and the fourth device 24 shown in the diagram.

Thus, the second device 22, the third device 23 and the fourth device 24 receives the object features thereof or the embedding vector thereof from the control center 200, and the object features or the embedding vector can be stored in the target object pool in each of the devices. The object features or the embedding vector can be used to compare with the image features of the motion images captured by the photographing module 125, so that these devices (22, 23, 24) can collaboratively achieve the cross-device object tracking method.

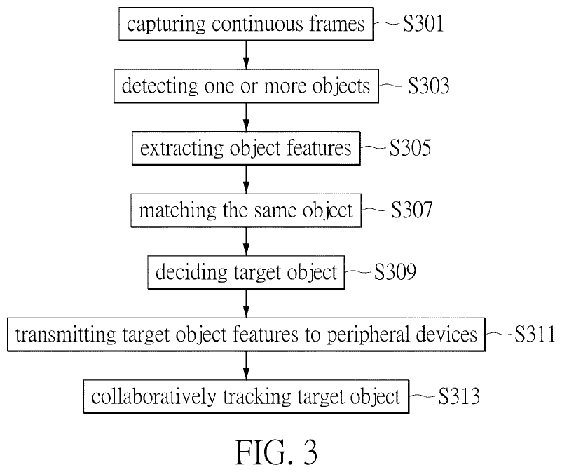

As shown in FIG. 3, in the cross-device object tracking method, a device uses a photographing module for capturing so as to obtain continuous frames in real time (step S301). The device performs a multi-object tracking algorithm (MOT) for detecting one or more objects in a current frame (step S303). An image-processing technology operated in the device extracts object features of each of the objects obtained from each frame (step S305). The object features can be compared with those of a previous frame buffered in the device's original object pool to match identical objects across consecutive frames. The same object existing in the preceding and following frames can be assigned with a same identifier (step S307). The identifier can be referred to for tracking the object.

Next, the object features of one or more objects to be detected in each frame are transmitted by the device to the control center. The control center designates the target object from the one or more objects (step S309). For example, any personnel in the control center can determine the target object to be tracked according to the image features of the one or more objects received from the device. After that, the object features or the embedding vector of the target object can be transmitted to the at least one peripheral device other than the device via multicasting transmission (step S311). Accordingly, the device and the at least one peripheral device can rely on the object features or the embedding vector of the target object to collaboratively track the target object (step S313).

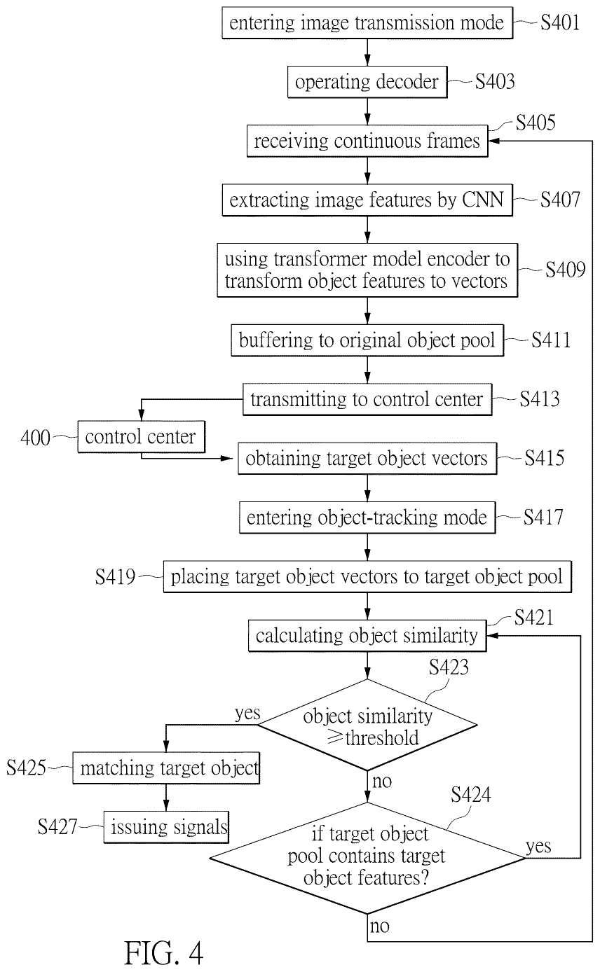

Reference is next made to FIG. 4, which is another flowchart illustrating the cross-device object tracking method according to another embodiment of the present disclosure.

In certain embodiments of the present disclosure, the terminal devices (e.g., the device and its peripheral device) that perform the cross-device object tracking method can be edge-computing devices that conduct edge computation, so that the terminal devices can individually perform the multi-object tracking algorithm (MOT).

In the device or any peripheral device, before the multi-object tracking algorithm is performed, the device firstly enters an image transmission mode (step S401) for operating the decoder of the transformer model (step S403) and then capturing continuous frames by the photographing module of the device (step S405).

The device operates a convolutional neural network to obtain image features of each frame and extract object features of one or more objects in the frame (step S407). The object features of the object can include one or any combination of a shape, material, and colors of the object. Afterwards, the encoder of the transformer operated in the device transforms the object features of each of the objects into an embedding vector (step S409). Next, the object features (e.g., the embedding vector) of the at least one object in a previous frame buffered in an original object pool of the device are retrieved (step S411), and provided for the decoder of the transformer model to compare the object features of the objects in the preceding and following frames to identify the object(s), which is to determine if any new object is present. In certain embodiments of the present disclosure, the device can transmit the object features that are extracted from the frames or the embedding vector that is obtained through calculation to a control center 400 (step S413), and the control center 400 can designate the target object to be tracked.

When the device or any of the peripheral devices receives the object features (e.g., embedding vector) of the target object from the control center 400 (step S415), the device or the peripheral device enters an object-tracking mode (step S417) and the object features (or the embedding vector) of the target object are buffered into a target object pool (step S419). Next, in the device, the embedding vector of any object obtained from each frame is compared with the embedding vector of the target object in the target object pool, and an object similarity can be frame-by-frame calculated (step S421). The object similarity is then compared against a preset similarity threshold to determine if it meets or exceeds the threshold (step S423). When the object similarity between each of the objects in each frame and the target object is calculated, it is determined that the object is not the target object, but a new object, since the object similarity is not larger than or equal to the similarity threshold (represented as “no”). The new object can be assigned with a new identifier and the process goes back to step S405 for comparing with the objects in a next frame. Alternatively, it is determined that the object is matched with the target object since the object similarity is larger than or equal to the similarity threshold (represented as “yes”) (step S425). Accordingly, the multiple devices achieve a purpose of cross-device collaborative object tracking, and any message relating to the matched object can be transmitted to the control center 400 (step S427).

Notably, the step S423 for determining whether the object similarity is larger than or equal to the threshold, when no target object is matched and it is confirmed that the target object pool does not record the object features thereof, the process can go back to the step S405 for performing the subsequent object-tracking steps; on the other hand, the process goes to step S421 for continuously using the object features thereof in the target object pool to generate one further object similarity by comparing with the object features of any object in a next frame if no target object is matched.

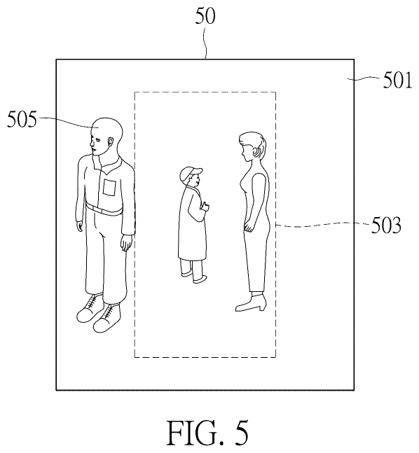

Notably, with consideration to limitations of computing resources and electrical capacity of the device, consumption of electricity can be saved by reducing the area of each of the frame to be calculated when the object-tracking operation is performed. For example, only the pixels of a rim area of the frame are calculated in the object-tracking operation, which can be referred to in FIG. 5, which is a schematic diagram depicting an image frame whose rim area is under the object-tracking operation according to one embodiment of the present disclosure.

With an image frame 50 shown in FIG. 5 as an example, for a purpose of detecting a target object 505, it is determined whether the target object 505 enters a coverage of the image frame 50. In general, the target object enters the coverage of the image frame 50 from the rim area of the frame. Therefore, the operation on a central area of the frame can be temporarily ignored, but the operation on the rim area of the frame requires priority. In FIG. 5, in order to save computing power, the image frame 50 is divided into a rim area 501 and a central area 503. The object-tracking operation can only be performed on the pixels of the rim area 501 of the image frame 50 for detecting a target object 505. Alternatively, according to one further embodiment of the present disclosure, a computing weight for the central area of the image frame can be decreased; for example, a frame rate for the central area of the image frame can be decreased or quantity of the pixels of the central area of the image frame can be reduced when the object-tracking operation is performed on the image frame.

In addition to above-mentioned requirement for reducing computing power of the device on the rim area of the image frame, in one further scenario, a computing frequency can be raised only if the target object gradually approaches the device from a distant location, since the object features (e.g., the shape, material or colors of the object) of the target object may be unidentifiable for an image-processing process in the distant place until the target object approaches the device within a specific distance. Accordingly, a series of computing time intervals for the device can be designed, and the computing frequency can be gradually raised when the target object approaches the device.

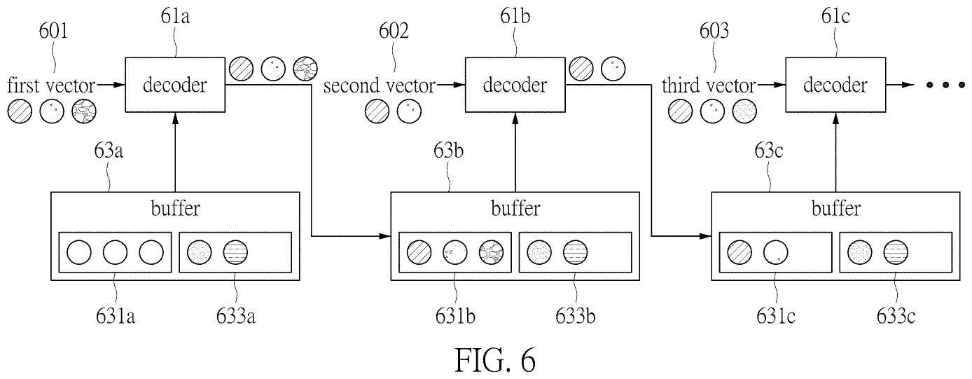

Based on the above embodiments of the present disclosure, reference is made to FIG. 6, which is a schematic diagram depicting a scenario that an edge-computing device or a control center uses an embedding vector to track an object according to one embodiment of the present disclosure. A device that performs the multi-object tracking algorithm operates a transformer model and uses a decoder of the transformer model to process the embedding vector that is obtained through calculations performed on the object features. A buffer of the device implements an original object pool and a target object pool. The original object pool stores an embedding vector of any object in a previous frame. The target object pool is used to buffer the embedding vector of the target object to be tracked.

According to the exemplary example shown in the diagram, when the device performs the multi-object tracking algorithm, the device can receive the embedding vector of the target object specified to be tracked from a control center. A normalization operation is performed on the embedding vector and the normalized embedding vector is stored in the target object pools (633a, 633b and 633c) of the buffer. The decoder of the device can be frame-by-frame represented by the decoders 61a, 61b and 61c. The buffer of the device can be frame-by-frame represented by the buffers 63a, 63b and 63c. The original object pool is used to frame-by-frame store the embedding vector of the object and schematically represented by the original object pools 631a, 631b and 631c. The target object pool can also be frame-by-frame represented by the target object pools 633a, 633b and 633c.

The device is able to frame-by-frame track the objects and retrieve the object features. The object features are transformed into the embedding vector. The embedding vector is firstly compared with the embedding vectors of the objects in a previous frame stored in the original object pool. If a comparison result indicates that there is a new embedding vector that fails to match any object, the embedding vector is then compared with the embedding vector of the target object recorded in the target object pool. The comparison is implemented by vector similarity calculation. The target object entering the frame is found to be matched if the vector similarity is higher than a similarity threshold preset by the cross-device object tracking system. After that, the device is configured to track the target object and send out a related message.

As FIG. 6 shows, the device obtains a first vector 601 of an object in a first frame through calculation. The decoder 61a of the transformer model of the device retrieves the embedding vector of the target object from the target object pool 633a of the buffer 63a. The embedding vector of the target object is compared with the first vector 601 so as to calculate a similarity. The similarity is referred to for determining whether the first vector 601 includes the target object or any new object. If the embedding vector does not match the target object, the new object is detected and can be assigned with a new identifier. If the embedding vector matches the target object, the device starts to track the target object.

According to the exemplary example shown in the diagram, the original object pool 631a of the buffer 63a does not store any embedding vector when a first frame is in processing. In the meantime, the first vector 601 is buffered to the original object pool 631b of the buffer 63b and the first vector 601 then becomes a reference to be compared for a next frame.

Next, the device receives a second vector 602 of a second frame through calculation. The decoder 61b obtains the embedding vectors of objects from both the original object pool 631b and the target object pool 633b of the buffer 63b. The second vector 602 is compared with the embedding vectors of the objects in a previous frame (e.g., in the original object pool 631b) so as to determine whether any new vector (i.e., a new object) is detected. The new vector is then compared with the embedding vector of the target object (e.g., in the target object pool 633b) for determining whether the new object is the target object. The second vector 602 is then stored in the original object pool 631c of the buffer 63c and provided for the device to process the embedding vectors of the objects in a next frame at a next time.

Similarly, the device obtains a third vector 603 of any object from a third frame through calculations. The decoder 61c obtains the embedding vectors of the objects in a previous frame from the original object pool 631c of the buffer 63c, and also obtains the embedding vector of the target object from the target object pool 633c. The embedding vector of the target object is compared with both the third vector 603 and the embedding vectors of the objects in the previous frame stored in the original object pool 631c so as to determine whether any new vector (i.e., a new object) is detected. The any new vector is compared with the embedding vector of the target object in the target object pool 633c so as to determine whether the new object is the target object, and then the comparison result is provided for the device to track the target object. The purposes of the multi-object tracking algorithm and target object tracking method can be achieved after repeating the process illustrated in FIG. 6.

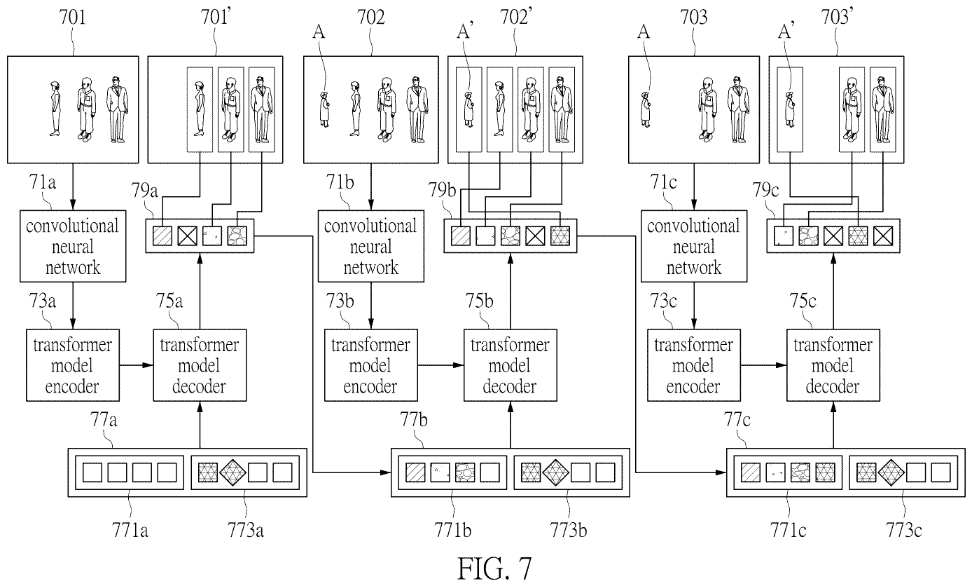

Reference is made to FIG. 7, which is a schematic diagram depicting a neural network architecture for implementing the cross-device object tracking method according to one embodiment of the present disclosure. A multi-object tracking (MOT) algorithm is used in the cross-device object tracking method for cooperating a convolutional neural network (CNN) and a transformer model to implement a trackformer. The convolutional neural network extracts object features from an image and an encoder of the transformer model transforms the object features into an embedding vector. After that, a decoder of the transformer model compares the embedding vector with an embedding vector (i.e., the object features) of any object in a previous frame from input images by a camera to match a same object. If any matched object is detected, an identifier of the object in the previous frame can be used for identifying the object in the following frames. The object to be identified can be labeled with a same color frame for achieving the object tracking method. The object features include a shape of the object, a material of the object and colors of the object and the decoder can compare the object features in the preceding and following frames so as to determine whether a same object is present in the preceding and following frames, by which an object trajectory can be established.

FIG. 7 schematically shows frame-by-frame states of components of a device at each time point. According to the exemplary example, when the device performs the multi-object tracking algorithm, an original object pool 771a of a buffer 77a is empty since no embedding vector is stored therein in the beginning. In addition, a following original object pool 771b of a buffer 77b and another following original object pool 771c of a buffer 77c respectively store the embedding vectors of the objects in respective previous frames. Further, all of the target object pools 773a, 773b and 773c store the embedding vector of the target object to be tracked and specified by a control center. As shown in the diagram, all of the target object pool 773a, 773b and 773c store the object features (i.e., the embedding vector) of the same target object to be tracked. The diagram also frame-by-frame depicts the neural network architecture that is operated in the device, in which convolutional neural networks 71a, 71b and 71c, encoders 73a, 73b and 73c of the transformer model and decoders 75a, 75b and 75c of the transformer model are shown in the diagram.

During operation, the device receives the embedding vector of the target object from the control center, performs normalization operation on this vector and stores the normalized embedding vector in the target object pool (773a, 773b, 773c) of the buffer (77a, 77b, 77c). Initially, the original object pool 771a contains no embedding vector, while each target object pool (773a, 773b, 773c) maintains the embedding vector representing the object features thereof received from the control center across successive frames during the tracking process.

The device receives a first frame 701 at a first time. The object features of any object in the first frame 701 can be extracted by the convolutional neural network 71a. The encoder 73a of the transformer model transforms the object features into an embedding vector. The embedding vector is then provided for the decoder 75a of the transformer model for determining if any new object appears in the frame. If there are multiple objects to be found in the frame, the objects can be assigned with different identifiers for identifying the different objects. For example, a matched object indicator 79a is provided for labeling the three objects appearing in a first object labeling zone 701′ with different section lines. The embedding vector of any object found in the first frame 701 is buffered to the original object pool 771b and provided for a purpose of matching the target object in a second frame 702.

Next, the embedding vector of one or more objects being detected from the first frame 701 is stored in the original object pool 771b of the buffer 77b. The target object pool 773b still stores the embedding vector of the target object to be tracked.

Afterwards, the device receives the second frame 702 at a second time, and the convolutional neural network 71b extracts the object features of any object in the second frame 702. The encoder 73b of the transformer model transforms the object features into an embedding vector, and the embedding vector is provided for the decoder 75b of the transformer model to compare with the embedding vector of any object in the second frame 702 and the embedding vector of any object in a previous frame (i.e., the first frame 701 in the present example) stored in the original object pool 771b to identify one or more objects in the second frame 702 and also determine whether any new object is detected.

In the process of using the embedding vector stored in the original object pool 771b to match any object in the second frame 702, if any new object is detected, the decoder 75b of the transformer model compares the embedding vector of the target object stored in the target object pool 773b. A similarity obtained by the comparison is referred to for confirming any object found in the second frame 702 and also determining whether the target object is detected in the second frame 702. The comparison result is similarly represented by a matched object indicator 79b that indicates the one or more objects found in the second frame 702 and also visualized as the one or more objects shown in a second object-labeling zone 702′.

As in the exemplary example shown in FIG. 7, three objects appear in the first frame 701 in the beginning. The three objects can be labeled in a first object-labeling zone 701′, and correspondingly shown in the matched object indicator 79a. The embedding vectors corresponding to the three objects are stored in the original object pool 771b. The embedding vectors of the objects in the second frame 702 are then obtained. In the present example, four objects are represented by different section lines in the matched object indicator 79b and appear in the second object-labeling zone 702′. When comparing with the embedding vectors of the objects stored in the original object pool 771b, a new object such as a new object A labeled in the second frame 702 is found. An embedding vector with respect to the new object A is calculated and then compared with the embedding vector of the target object stored in the target object pool 673b so as to confirm that a new object A′ shown in the second object-labeling zone 702′ is the target object.

Similarly, the embedding vectors obtained from the second frame 702 at the second time point are stored in the original object pool 771c. The embedding vectors are used by the device to compare with the embedding vectors of objects found in the next frame. The target object pool 773c still stores the embedding vector of the target object.

Next, the device receives a third frame 703 at a third time point, and the convolutional neural network 71c extracts the object features from the third frame 703. The encoder 73c of the transformer model transforms the object features into embedding vectors. The embedding vectors are provided to the decoder 75c of the transformer model to compare with the embedding vectors of objects of a previous frame stored in the original object pool 771c to identify one or more objects in the third frame 703 and also determine whether any new object is found. If a new object is found, the decoder 75c of the transformer model compares with the embedding vector of the target object stored in the target object pool 773c. A similarity is calculated according to a comparison result. The similarity is referred to for confirming the objects shown in the third frame 703 and also determining whether the target object is detected in the third frame 703.

As an exemplary example shown in the diagram, the third frame 703 contains one fewer object than the second frame 702. After comparing the embedding vectors of objects in the previous frame stored in the original object pool 771c, a new object (i.e., new object A) is detected in the third frame 703, along with two other objects found in the previous frame. A matched object indicator 79c labels the three objects found in the third frame 703 with different section lines. The three objects are visualized and shown in a third object-labeling zone 703′ that also includes the new object A′.

After repeating the above steps, the new object that is determined as the target object can be continuously tracked, and the purpose of tracking the target object with a neural network architecture is achieved. Further, according to one further embodiment of the cross-device object tracking method, the target object and changes in positions of the target object can be frame-by-frame detected in the continuous frames by the device according to correlations of the object vectors in the preceding and following frames. Thus, the device can provide the information about the target object obtained from the continuous frames to the control center, which can then transmit the object features thereof to the other peripheral devices that are geographically correlated with the device via multicasting transmission, thereby enabling collaborative tracking of the target object by multiple devices.

The device and the one or more peripheral devices can be grouped based on correlations relating to their geographical locations. Accordingly, the object features of the target object can be transmitted from any of the devices or via the control center to the one or more peripheral devices in the same group via multicasting transmission. Each device may individually implement an edge-computing device capable of operating the convolutional neural network and the transformer model. Notably, only the pixels in a rim area of each frame are processed by each device to achieve cross-device object tracking method.

When the cross-device object tracking method is in operation, a combination of devices for collaborative operation can be decided according to an application scenario. For example, the combination can be a mobile device cooperated with at least one further mobile device, a mobile device cooperated with at least one fixed device, a fixed device cooperated with at least one mobile device, or multiple fixed devices that are collaboratively operated.

Notably, since each of the mobile devices can only capture and track the object within a limited coverage, the control center can transmit the embedding vector of the target object to the mobile devices worn by multiple security personnel in the same scenario, and specifically the embedding vector of the target object is stored in the target object pool in each of the mobile devices, and also be transmitted to a memory of any fixed camera device in the same scenario. Therefore, any suspect (i.e., the target object) can be tracked through collaboration of the multiple devices that individually operates a multi-object tracking algorithm from different fields of vision, and an alarm message can be sent to the control center when any device confirms that the suspect is captured.

What is claimed is:

1. A cross-device object tracking method, collaboratively performed by a device and at least one peripheral device, wherein the method comprising:
capturing, by a photographing module of the device, a sequence of continuous frames, and performing a multi-object tracking algorithm to detect at least one object in a current frame and extract object features of the at least one detected object;
comparing object features of a previous frame, buffered in an original object pool of the device, to identify a new object;
comparing object features of the new object with those of a target object stored in a target object pool of the device to confirm that the target object has been captured; and
relying, by the at least one peripheral device, on the object features of the target object stored in its target object pool to collaboratively track the target object with the device.

2. The cross-device object tracking method according to claim 1, wherein the device and the at least one peripheral device are communicated via a communication channel for transmitting the object features of the target object.

3. The cross-device object tracking method according to claim 1, wherein, in the device or the at least one peripheral device, a convolutional neural network is applied to extract object features of the at least one object in each frame, and an encoder of a transformer model transforms the object features of the at least one object into an embedding vector that is provided for a decoder of the transformer model to match one or more objects by comparing the object features in preceding and following frames.

4. The cross-device object tracking method according to claim 3, wherein the device and the at least one peripheral device each implement an edge-computing device that operates the convolutional neural network and the transformer model for performing calculation only on pixels of a rim area of each frame.

5. The cross-device object tracking method according to claim 3, wherein, when the device or the at least one peripheral device obtains the embedding vector of the target object, the embedding vector of the target object is referred to for tracking the target object.

6. The cross-device object tracking method according to claim 1, wherein the device and the at least one peripheral device are grouped based on correlations of geographical locations of the devices, and the device transmits the object features of the target object to the one or more peripheral devices in a same group via multicasting transmission.

7. The cross-device object tracking method according to claim 1, wherein an object similarity is calculated when comparing the object features of the target object with the object features in a previous frame buffered in the original object pool of the device; and wherein the new object is matched with the target object when the object similarity is larger than or equal to a threshold, and the new object is not matched with the target object when the object similarity is smaller than the threshold, and the new object is assigned a new identifier.

8. A cross-device object tracking method, collaboratively performed by a device and at least one peripheral device, wherein the method comprises:
capturing, by a photographing module of the device, a sequence of continuous frames;
performing a multi-object tracking algorithm to detect at least one object in a current frame and to extract object features of the at least one detected object;
comparing the object features of the at least one detected object in the current frame with the object features of objects from a previous frame, which are stored in an original object pool of the device, to identify a new object;
comparing the object features of the new object with object features of a target object that are provided by a control center in a target object pool of the device to confirm that the target object has been captured; and
collaboratively tracking the target object by the at least one peripheral device and the device based on the object features of the target object stored in their respective target object pools.

9. The cross-device object tracking method according to claim 8, wherein, in the device or the at least one peripheral device, a convolutional neural network is applied to extract the object features of the at least one object in each frame, and an encoder of a transformer model transforms the object features of the at least one object into an embedding vector that is provided for a decoder of the transformer model to match one or more objects by comparing the object features in preceding and following frames.

10. The cross-device object tracking method according to claim 9, wherein the device and the at least one peripheral device each implement an edge-computing device that operates the convolutional neural network and the transformer model for performing calculation only on pixels of a rim area of each frame.

11. The cross-device object tracking method according to claim 9, wherein, when the device or the at least one peripheral device obtains the embedding vector of the target object, the embedding vector of the target object is referred to for tracking the target object.

12. The cross-device object tracking method according to claim 8, wherein the device and the at least one peripheral device are grouped based on correlations of geographical locations of the devices, and the control center transmits the object features of the target object to the one or more peripheral devices in a same group via multicasting transmission.

13. The cross-device object tracking method according to claim 12, wherein an object similarity is calculated when comparing the object features of the target object with the object features in a previous frame buffered in the original object pool of the device; and wherein the new object is matched with the target object when the object similarity is larger than or equal to a threshold, and the new object is not matched with the target object when the object similarity is smaller than the threshold, and the new object is assigned a new identifier.

14. A cross-device object tracking system, comprising:
a device and at least one peripheral device, wherein the device and the at least one peripheral device are interconnected and collaboratively operate a cross-device object tracking method comprising:
capturing continuous frames by a photographing module of the device, and performing a multi-object tracking algorithm to detect at least one object in a current frame and obtain object features of the at least one object;
comparing the object features of a previous frame buffered in an original object pool of the device to identify a new object;
comparing the object features of the new object with the object features of a target object stored in a target object pool of the device to confirm that the target object is captured; and
relying, by the at least one peripheral device, on the object features of the target object stored in the target object pool of the at least one peripheral device to collaboratively track the target object with the device.

15. The cross-device object tracking system according to claim 14, further comprising a control center, wherein the device and the at least one peripheral device are connected with the control center via a communication channel, and the at least one peripheral device receives the object features of the target object via the control center and buffers the object features of the target object to the target object pool.

16. The cross-device object tracking system according to claim 15, wherein the target object is tracked through collaboration of the device and the at least one peripheral device that individually operates a multi-object tracking algorithm from different fields of vision, and an alarm message is sent to the control center when any device confirms that the target object is captured.

17. The cross-device object tracking system according to claim 15, wherein, when the device or the at least one peripheral device obtains an embedding vector of the target object, the embedding vector of the target object is referred to for tracking the target object.

18. The cross-device object tracking system according to claim 14, wherein an object similarity is calculated when comparing the object features of the target object with the object features in a previous frame buffered in the original object pool of the device; and wherein the new object is matched with the target object when the object similarity is larger than or equal to a threshold, and the new object is not matched with the target object when the object similarity is smaller than the threshold, and the new object is assigned with a new identifier.

19. The cross-device object tracking system according to claim 14, wherein, in the device or the at least one peripheral device, a convolutional neural network is applied to extract the object features of the at least one object in each frame, and an encoder of a transformer model transforms the object features of the at least one object into an embedding vector that is provided for a decoder of the transformer model to match one or more objects by comparing the object features in preceding and following frames.

20. The cross-device object tracking system according to claim 19, wherein the device and the at least one peripheral device each implement an edge-computing device that operates the convolutional neural network and the transformer model for performing calculation only on pixels of a rim area of each frame.
